(19) United States
(12) Patent Application Publication
(10) Pub. No.: US 2025/0344140 A1
(43) Pub. Date: Nov. 6, 2025

(54) ALLOCATING NETWORK SLICES TO USER EQUIPMENT

(71) Applicant: T-MOBILE INNOVATIONS LLC, Overland Park, KS (US)

(72) Inventor: Baewon SEO, Overland Park, KS (US)

(21) Appl. No.: 18/656,330

(22) Filed: May 6, 2024

(51) Int. Cl. H04W 48/18; H04M 1/72484; H04W 48/02

(52) U.S. Cl. CPC H04W 48/18; H04M 1/72484; H04W 48/02

(57) ABSTRACT

Embodiments of the present disclosure are directed to systems and methods for allocating different network slices to airborne frequency bands. More particularly, in aspects set forth herein, systems and methods are directed to a network slicing paradigm that could be used to enable the provision of service to UEs in the air. By creating virtual partitions in the network, network slicing allows mobile operators to customize treatment for specific traffic flows or applications, including those from airborne UEs. This enables tailored services, such as prioritizing low-latency connections for critical flight communications or allocating enhanced resources for data-intensive applications, thereby optimizing connectivity and performance for airborne UEs while minimizing power consumption.

### SUMMARY

The present disclosure is directed to improving the telecommunications service of a user equipment (UE), substantially as shown and/or described in connection with at least one of the Figures, and as set forth more completely in the claims.

According to various aspects of the technology, dynamic network slicing is utilized to enable and disable dedicated slices for users based on their network, application, and subscription requirements. In some instances, UE may be assigned to a specific network slice to ensure a particular allocation of network resources to the UE, such as when accessing or utilizing specific applications or services. Additionally, the UE may initiate an application that requires or requests additional network resources beyond what the currently assigned slice can support. The network can then assign a different network slice, to which the user is subscribed, allowing the UE to display an icon indicating the usage of the subscribed network slice.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 depicts an exemplary computing device for use with the present disclosure;

FIG. 2 depicts a diagram of an exemplary network environment in which implementations of the present disclosure may be employed, in accordance with aspects herein;

FIG. 3 depicts dynamic network slicing in a network, in which implementations of the present disclosure may be employed, in accordance with aspects herein;

FIG. 4 depicts an exemplary display of a user device using dynamic network slicing in a network, in which implementations of the present disclosure may be employed, in accordance with aspects herein and

FIG. 5 is a flow diagram of a method for dynamically allocating network resources to devices in a network, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, network slicing is an architectural paradigm in telecommunication networks wherein network resources are logically partitioned into multiple virtual networks, or “slices,” each catering to distinct service requirements. Network slicing allows for the allocation and isolation of resources such as computing, storage, and bandwidth and can be customized with specific Quality of Service (QoS) characteristics, latency profiles, and security parameters to meet the unique demands of diverse applications, services, or user groups. Using network slicing, mobile network operators can efficiently share a common network infrastructure while accommodating the different needs of services including ultra-reliable low-latency communication (URLLC) and enhanced mobile broadband (eMBB).

Conventionally, the management of network slices involves a static allocation system where each UE is assigned a fixed slice based on predetermined criteria such as the type of service, user subscription level, and expected resource usage. This traditional method relies heavily on network operators' ability to forecast demand and configure network resources accordingly, often resulting in underutilized or overstretched resources. Network configurations are typically updated during maintenance windows, limiting the system's ability to respond to sudden changes in traffic or service requirements. Additionally, this approach does not account for real-time variations in network use, leading to potential service disruptions and an inability to maximize network efficiency. As a result, conventional network slicing often struggles to provide the flexibility and scalability required by modern network environments.

Unlike conventional solutions, the present disclosure introduces a dynamic network slicing system that overcomes the limitations of static allocations by leveraging real-time data. This system identifies whether UE requires or requests additional or different network resources, and facilitates access through various network slices. It employs a permission-based model, restricting access to specific network slices to authorized UEs only. Additionally, the system monitors which network slice a UE is utilizing and triggers the display of an icon on the UE, indicating active utilization of that slice. This feature enhances user awareness, ensuring they are informed about their accessing the services and network slices for which they have permissions.

Accordingly, a first aspect of the present disclosure is directed to a method for allocating network slices to a UE, the method comprises receiving a request by a user of the UE to open an application on the UE. The method also comprises determining that the UE has been allocated a first network slice, determining that the application requires a second network slice, and then allocating to the UE, the second network slice. The method also includes causing to be displayed on a display of the UE, a first icon representing the allocation of the second network slice.

A second aspect of the present disclosure is directed to a system for allocating network slices to UE, the system comprises one or more processors and one or more computer-readable media storing computer-usable instructions that, when executed by the one or more processors, cause the one or more processors to monitor UE network requirements. The system also determines that the UE has been allocated a first network slice. The system further determines, based on the UE network requirements, that the UE requires a second network slice and that the UE has one or more permissions to access the second network slice. The system finally allocates to the UE, the second network slice.

Another aspect of the present disclosure is directed to one or more non-transitory computer-readable media having computer-usable instructions embodied thereon that, when executed by one or more processors, cause the processors to monitor UE network requirements. The processors also determine that the UE has been allocated a first network slice. The processors further determine, based on the UE network requirements, that the UE requires a second network slice and that the UE has one or more permissions to access the second network slice. The processors finally allocate to the UE, the second network slice.

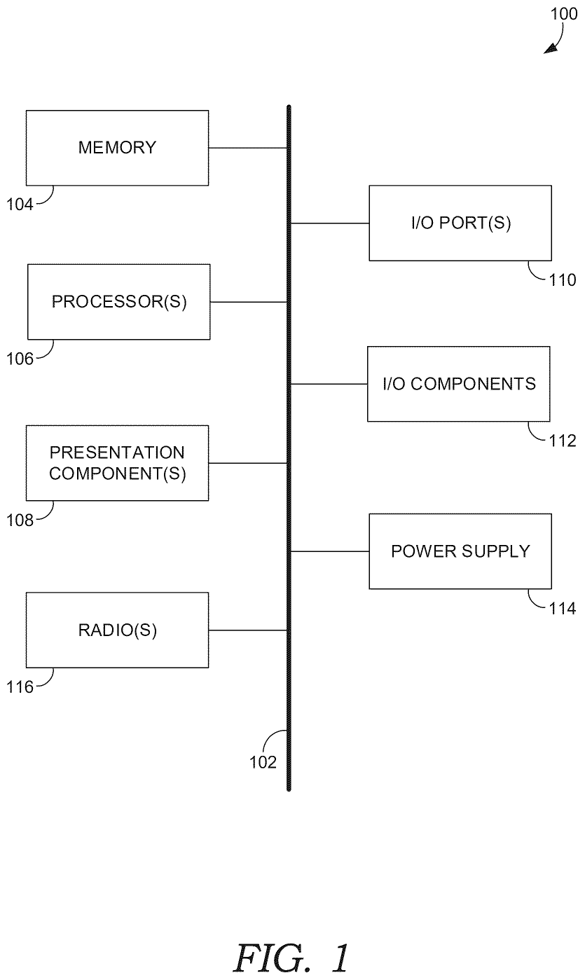

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment, wireless communication device, or user device, The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid-state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, non-removable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

A first radio 120 and second radio 130 represent radios that facilitate communication with one or more wireless networks using one or more wireless links. In aspects, the first radio 120 utilizes a first transmitter 122 to communicate with a wireless network on a first wireless link and the second radio 130 utilizes the second transmitter 132 to communicate on a second wireless link. Though two radios are shown, it is expressly conceived that a computing device with a single radio (i.e., the first radio 120 or the second radio 130) could facilitate communication over one or more wireless links with one or more wireless networks via both the first transmitter 122 and the second transmitter 132. Illustrative wireless telecommunications technologies include CDMA, GPRS, TDMA, GSM, and the like. One or both of the first radio 120 and the second radio 130 may carry wireless communication functions or operations using any number of desirable wireless communication protocols, including 802.11 (Wi-Fi), WiMAX, LTE, 3G, 4G, LTE, 5G, NR, VoLTE, or other VoIP communications. In aspects, the first radio 120 and the second radio 130 may be configured to communicate using the same protocol but in other aspects they may be configured to communicate using different protocols. In some embodiments, including those that both radios or both wireless links are configured for communicating using the same protocol, the first radio 120 and the second radio 130 may be configured to communicate on distinct frequencies or frequency bands (e.g., as part of a carrier aggregation scheme). As can be appreciated, in various embodiments, each of the first radio 120 and the second radio 130 can be configured to support multiple technologies and/or multiple frequencies; for example, the first radio 120 may be configured to communicate with a base station according to a cellular communication protocol (e.g., 4G, 5G, 6G, or the like), and the second radio 130 may configured to communicate with one or more other computing devices according to a local area communication protocol (e.g., IEEE 802.11 series, Bluetooth, NFC, z-wave, or the like).

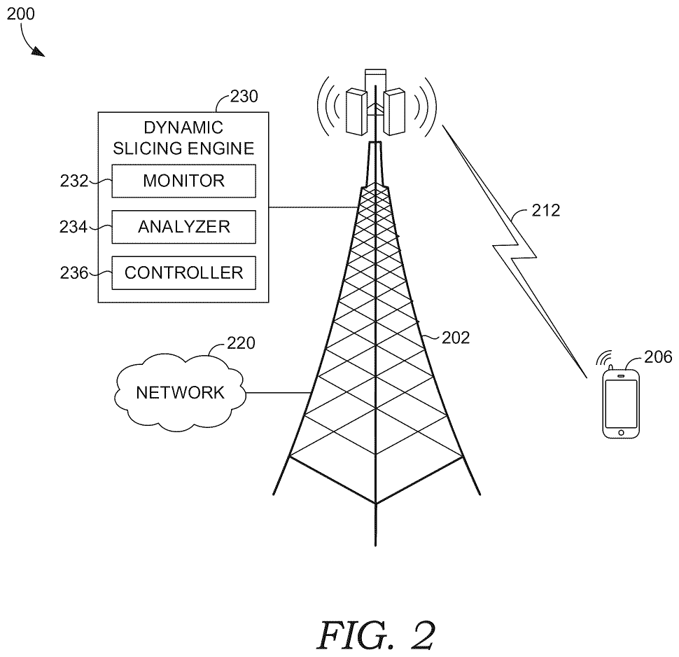

FIG. 2 illustrates an example of a network environment 200 suitable for use in implementing embodiments of the present disclosure. Such a network environment is illustrated and designated generally as network environment 200. At a high level the network environment 200 comprises a UE 206, one or more base stations (e.g., base station 202), one or more communication channels (e.g., frequency band 212), and one or more networks (e.g., network 220). The frequency band 212 can communicate over a frequency band assigned to the carrier. Though the UE 206 is depicted as a cell phone, a UE suitable for implementations with the present disclosure may be any computing device that is connected to a base station having any one or more aspects described with respect to FIG. 1. Similarly, though the base station 202 is illustrated as a macro cell on a cell tower, any scale or form of access point acting as a transceiver station for wirelessly communicating with a UE, including small cells, pico cells, and the like, are suitable for use with the present disclosure.

The network environment 200 comprises a base station 202 with one or more sets of frequency bands 212 to which both the UE 206 can potentially connect to (also referred to as ‘camping on,’ ‘attaching’ in the industry). Though the network environment 200 is illustrated with one base station 202, one skilled in the art will appreciate that more base stations may be present in any particular network environment.

The base station 202 can be associated with one or more at least partially distinct networks, wherein each network is associated with one or more network identifiers. Each network may be a telecommunications network(s) (e.g., a packet data network or core network), data network, or portions thereof. A telecommunications network that at least partially comprises the network environment 200 may include additional devices or components (e.g., one or more base stations) not shown. Those devices or components may form network environments similar to what is shown in FIG. 2, and can also perform methods in accordance with the present disclosure. Components such as terminals, links, and nodes (as well as other components) may provide connectivity in various implementations. For the purposes of illustrating the present disclosure, the base station 202 may be connected to the network 220. The network 220 may include multiple networks, as well as being a network of networks, but is shown in more simple form so as to not obscure other aspects of the present disclosure.

The base station 202 is configured to transmit downlink signals to one or more UEs, such as the UE 206, and to receive uplink signals from them. These downlink signals typically include various sets of synchronization signals, such as primary synchronization signals (PSS), secondary synchronization signals (SSS), and physical broadcast channel (PBCH) signals, which provide essential information about the base station 202. Additionally, the downlink signals may contain various other control and broadcast signaling, including physical downlink shared channel (PDSCH) signaling. In practical terms, when a UE initiates communication, it scans a broad range of frequencies to identify available base stations. This scanning process involves tuning to a frequency and monitoring for synchronization signals, like the master information block (MIB), transmitted from nearby cells. Once these synchronization signals are detected and decoded, the UE assesses the suitability of each cell based on factors such as signal strength and quality. Subsequently, the UE listens for additional signals, such as system information block one (SIB1), to complete the attachment process.

Network slicing is a type of network functionality that logically defines one or more network resources in order to provide a certain quality of service (QOS) or make available a certain amount of network resources for certain types of devices or activities. Each slice of traffic may have its own resource requirements, QoS, security configuration, and latency requirements. For example, a network slice supporting high definition streaming video has different requirements from a network slice monitoring a simple Internet of Things (IoT) device, such as a motion detector. Referring to FIG. 2, network 220 dynamically allocates network slices based on the specific needs of a UE, such as UE 206, or the applications it runs. Allocation occurs when an application launches or upon the UE's initial network connection. The network 220 evaluates the demands of UE 206 and the running applications and assigns the most suitable network slices for active applications. Before allocation, network 220 determines whether the user of UE 206 has a subscription for specialized network slices, such as those required for autonomous vehicles, which demand ultra-low latency. For example, a user could have a subscription tailored specifically for autonomous vehicle applications, allowing access to dedicated network slices. The network adapts these slices in response to changes in application use or at the end of a set time-period, ensuring optimal performance and efficient resource management that meets the real-time needs of the UE.

In alternative aspects, when UE 206 connects to frequency band 212, it may initially use a basic network slice. By creating network slices within network 200, tailored services can be provided to each user, such as prioritizing low-latency connections or allocating enhanced resources for data-intensive applications, thereby optimizing connectivity and performance while minimizing power consumption. For instance, different service limitations might be desirable depending on the user application's or the user's needs. One application might require only basic services (e.g., voice and SMS but no data), while another might require more advanced options (e.g., network slicing tailored for gaming, streaming, or autonomous vehicle applications). To accommodate these requirements, a multi-tier subscription model can be implemented where each tier corresponds to a unique network slice with specific capabilities. For example, the first network slice might be allocated for a basic level of service, allowing access to voice calls and SMS but not data. This level could be prioritized based on the user's subscription status. A second network slice could correspond to a more advanced tier, requiring a subscription and offering extensive features such as voice calls, SMS, and data streaming. This tier could also receive prioritization, providing enhanced services according to user demands. An additional level could be subscribed to that would be tailored to an ultra-low latency requirement but low bandwidth requirements.

The dynamic slicing engine 230 is generally configured to make and carry out dynamic slicing decisions according to one or more aspects of the present disclosure. The dynamic slicing engine 230 may be said to comprise a monitor 232, an analyzer 234, and a controller 236. The monitor 232 is generally configured to monitor requests from the one or more UEs that are requesting network resources via the base station 202. The monitor 232 is configured to process requests to determine their association with specific network slices. For instance, if a mobile network operator has designated a network slice primarily for SMS, the monitor 232 processes an SMS request from a UE and allocates it to this predefined slice. Similarly, requests for services requiring low latency, like video calling or data streaming, are identified by the monitor 232 and directed to another appropriate network slice designed for high-performance needs.

The analyzer 234 is generally configured to determine the utilization of the base station 202 and various network slices. In a first aspect, the analyzer 234 may be configured to inspect a UE's behavior to determine if the UE is fully utilizing a network slice; for example, the monitor 232 may determine that the UE is using a video conferencing application, the analyzer 234 may determine that said UE is only utilizing one sub-service of the video conferencing application and is not using a second sub-service. In such an example, even though the UE is using a video conferencing application, the analyzer 234 may determine that only the audio stream is being used (and that the video portion is not being used/requested by the UE). Further, the analyzer 234 can determine the network requirements of a UE, such as UE 206, or an application being used by the UE 206. The Analyzer 234 can identify that the application running on UE 206 requires a network slice that is associated with video conferencing. The Analyzer 234 is designed to monitor UE selection policy rules that are associated with specific applications running on the network. This involves assessing the rules that dictate which network resources or slices are assigned or requested based on the specific requirements of the applications being used.

Further, the network can provide services that allow UEs, such as UE 206 to access particular network slices only with a subscription. For example, UE 206 can use a network slice that is tailored to video conferencing only if the UE 206 is subscribed to use that network slice. The analyzer 234 can analyze the user's subscriptions to determine if the UE can use a particular network slice that would allow the applications usage to be optimized. For example, if the analyzer 234 determines that the UE 206 is running a video conferencing application, the analyzer can then determine if the user has subscribed to a network slice that would optimize or provide for the performance needs of the video conferencing application. The analyzer 234 can determine if the UE 204 has one or more permissions to access a particular network slice. This is done by checking permissions against a subscription database that records subscription levels and service entitlements for each UE.

The controller 236 is generally configured to determine that a network slicing modification trigger has occurred and to determine and cause a modification to a network slicing allocation. The network slicing modification trigger can cause the controller 236 to make a modification to a network slicing allocation. In a first aspect, the network slicing modification trigger may comprise a determination by the analyzer 234 that the current network slice does not meet the performance requirements of an application running on UE 206. In such an aspect, the controller 236 may either modify the network slicing assignment for UE 206 which is connected to the base station 202 by assigning a network slice adequately supports the performance requirements of the application. In another aspect, the UE 206 may request from the network 220 to be assigned a particular network slice. For example, the UE 206 may open an application and upon initializing the application, a request can be sent requesting a particular network slice that would support the performance requirements of the application.

In another aspect, the controller 236 can modify the network slicing assignment for UE 206 that is determined to not be fully supported by their current network slice (e.g., a UE that is using a video conferencing service and a network slice tailored to only audio calls). In such an aspect, the controller 236 may make a change to a UE's network slice access based on the UE underutilizing that slice (e.g., only using the audio portion of a video conferencing service). In any aspect, the controller 236 can modify the network slice assignment/access of the UE by scaling back or increasing the UE's allocated network slicing resources. The controller can also assign the UE 206 to a network slice that uses fewer or greater network resources or has a reduced or increased QOS compared to the default network slice associated with the UE's original assignment or allocation.

Once the controller 236 has modified the network slicing assignment for UE 206, the controller 236 can cause to be displayed on the UE 206 an icon representing the network slice being assigned to the UE 206. For example, if the UE 206 opens a video conferencing application it can request the network to assign a video conferencing network slice to the UE 206. The network 220 can then determine that the UE 206 is subscribed to a video conferencing slice and subsequently assign that slice to the UE 206. Once assigned, the controller 236 can cause a display on the UE 206 to display an icon representing the video conferencing network slice.

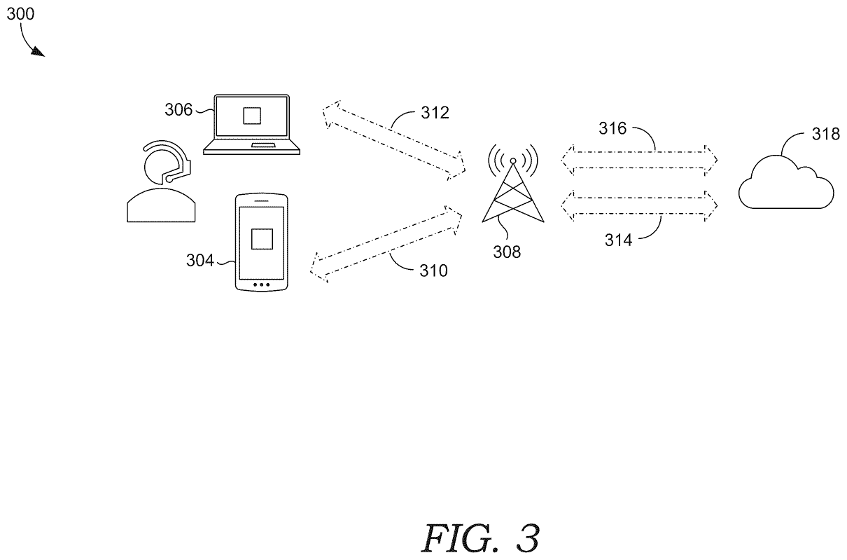

FIG. 3 depicts dynamic network slicing in a network, in which implementations of the present disclosure may be employed, in accordance with aspects herein. In a network 300, multiple devices may make similar requests to connect with a network. In accordance with one or more aspects described with respect to FIG. 2, a first UE 304 requests access to a network service 318 from a radio access network node 308, via connection 310, and a second UE 306 requests access to the network service 318 from the radio access network node 308 via connection 312. Because the first UE 304 and the second UE 306 are requesting access to the same network service 318, such as tier one described above, they are initially assigned to a first network slice 314. However, if a network slicing modification trigger occurs, changes may be necessary. Triggers can include the initialization of an application within a UE that requires additional network resources, a direct network slice modification request, or any other aspect as described with respect to FIG. 2. As a result of such triggers, one or both UEs—either the first UE 304 or the second UE 306—may need to be reassigned to a second network slice 316. This second network slice 316 offers more network resources or a higher Quality of Service (QoS) than the first network slice 314, corresponding to what might be considered tier two as previously mentioned.

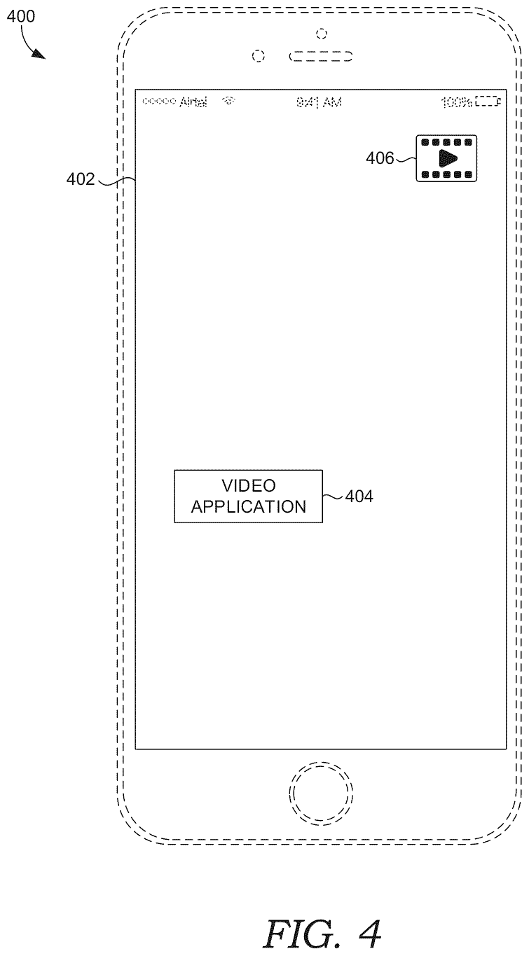

Turning now to FIG. 4, which displays an example diagram 400 of a display shown in a graphical user interface (GUI) in accordance with aspects herein. The diagram 400 shows an example display screen 402 on an example UE to be used with aspects herein. The display screen 402 can display a plurality of icons such as an application icon 404. When a user selects the application icon 404, the application can initialize. As part of the initialization, the UE can determine that additional resources are required to adequately run the application. The UE can then send a request to the network to assign a particular network slice to the UE. This network slice may be associated with a subscription that the UE is part of. Once the network assigns a particular network slice to the UE, the UE can then provide a display of an icon, such as slicing icon 406. For example, if the application to be run on the UE is a video conferencing application, the network can then assign a network slice tailored to video conferencing. The UE can then display the slicing icon 406 that represents the network slice tailored to video conferencing. This allows the user to know that they are accessing network resources that they have subscribed to.

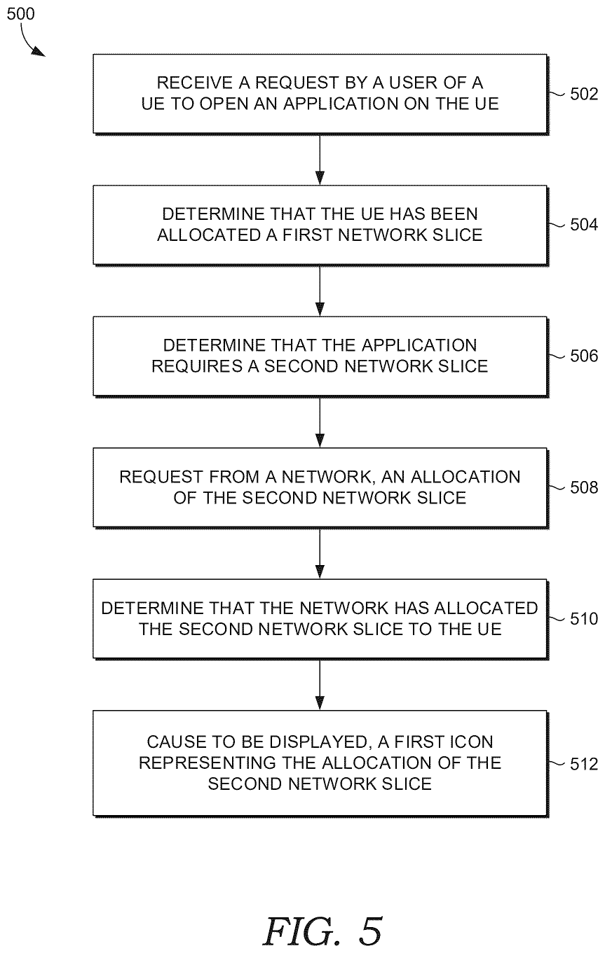

Turning now to FIG. 5, a flow chart representing a method 500 is provided. Generally the method 500 may be used by a UE, such as UE 206 of FIG. 2. At a first step 502, the network receives a request by a user of a UE to open an application on the UE. At a second step 504, the network determines that the UE has been allocated a first network slice. At a third step 506, the network determines that the application requires a second network slice. At a fourth step 508, the network requesting from a network, an allocation of the second network slice. At a fifth step 510, the network determines that the network has allocated the second network slice to the UE. At a sixth step 512, the network causes to be displayed on the UE, a first icon representing the allocation of the second network slice.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A method for allocating network slices to a user equipment (UE), the method comprising:
determining that the UE has an application running on the UE;
determining that the UE has been allocated a first network slice;
determining that the application running on the UE requires a second network slice;
determining that the UE has one or more permissions to access the second network slice; and
allocating to the UE, the second network slice, wherein allocating the second network slice comprises causing the UE to display a first icon, wherein the first icon is displayed with one or more visual indicators of the second network slice.

2. The method of claim 1, wherein the allocation of the first network slice is based on the UE initially being connected to a network.

3. The method of claim 2, wherein the first network slice is allocated for a first level of service.

4. The method of claim 3, wherein the first level of service enables the UE to access phone calls and SMS.

5. The method of claim 1, wherein the second network slice comprises a second level of service.

6. The method of claim 1, further comprising de-allocating the first network slice once the second network slice has been allocated.

7. The method of claim 1, further comprising monitoring a usage of the second network slice.

8. The method of claim 1, wherein determining that the application requires the second network slice comprises monitoring a UE selection policy rule associated with the application.

9. A system for allocating network slices to a user equipment (UE), the system comprising:
one or more processors; and
one or more computer-readable media storing computer-usable instructions that, when executed by the one or more processors, cause the one or more processors to:
monitor one or more UE network requirements;
determine that the UE has been allocated a first network slice;
determine, based on the one or more UE network requirements, that the UE requires a second network slice;
determine that the UE has one or more permissions to access the second network slice;
allocate the second network slice to the UE; and
cause the UE to display a first icon based on the second network slice allocation.

10. The system of claim 9, wherein determining that the UE requires the second network slice is further based on an application-specific request initiated when a user starts a particular application on the UE.

11. The system of claim 9, wherein the one or more permissions to access the second network slice are verified against a subscription database.

12. The system of claim 9, wherein the first icon is displayed with one or more visual indicators of the second network slice.

13. The system of claim 9, wherein the second network slice comprises a second level of service.

14. The system of claim 9, wherein the first network slice is allocated to a first level of service.

15. The system of claim 14, wherein the first level of service enables the UE to access phone calls and SMS.

16. One or more non-transitory computer-readable media having computer-usable instructions embodied thereon that, when executed by one or more processors, cause the one or more processors to:
receive a request at a user equipment (UE) to initiate an application;
determine that a network has allocated a first network slice to the UE;
determine, based on the application requirements, that the application requires a second network slice, wherein the UE has one or more permissions to access the second network slice;
communicate a request to the network to allocate the second network slice to the UE; and
receive an indication that the network has allocated to the UE, the second network slice; and
causing a first icon to be displayed on a user interface of the UE wherein the first icon indicates the second network slice allocation.

17. The non-transitory computer-readable media of claim 16, wherein the first network slice is allocated to a first level of service.

18. The non-transitory computer-readable media of claim 16, wherein the second network slice is allocated to a second level of service.

19. The non-transitory computer-readable media of claim 16, further comprising instructions to notify a user of the UE about the allocation of the second network slice through a user interface element displayed on the UE.

20. The non-transitory computer-readable media of claim 16, wherein the first icon is displayed with one or more visual indicators of the second network slice.
